(19) United States
(12) Patent Application Publication
(10) Pub. No.: US 2026/0023028 A1
(43) Pub. Date: Jan. 22, 2026

(54) INSPECTION APPARATUS AND METHOD

(71) Applicant: SAMSUNG ELECTRONICS CO, LTD., Suwon-si (KR)

(72) Inventors: Jaehwang JUNG, Suwon-si (KR); Moo Seok JANG, Daejeon (KR); Jong In YOU, Daejeon (KR); Taejeoong KIM, Suwon-si (KR); Myungjun LEE, Suwon-si (KR); Yeny YIM, Suwon-si (KR)

(73) Assignees: SAMSUNG ELECTRONICS CO, LTD., Suwon-si (KR); KOREA ADVANCED INSTITUTE OF SCIENCE AND TECHNOLOGY, Daejeon (KR)

(21) Appl. No.: 19/044,065

(22) Filed: Feb. 3, 2025

(30) Foreign Application Priority Data
Jul. 16, 2024 (KR) 10-2024-0093850

(51) Int. Cl. G01N 21/88; G01N 21/47; G01N 21/95

(52) U.S. Cl. CPC G01N 21/8851; G01N 21/4788; G01N 21/8806; G01N 21/9501; G01N 2021/8835; G01N 2021/8845

(57) ABSTRACT

An inspection method includes: obtaining a plurality of diffraction images of an inspection target object by performing a plurality of lighting cycles in which a plurality of light sources are configured to sequentially irradiate light onto the inspection target object; and obtaining an output image of the inspection target object based on the plurality of diffraction images, wherein for each of the plurality of lighting cycles, the light irradiated to the inspection target object has a different wavelength range.

### CROSS-REFERENCE TO RELATED APPLICATION

This application is based on and claims priority under 35 U.S.C. § 119 to Korean Patent Application No. 10-2024-0093850, filed on Jul. 16, 2024, in the Korean Intellectual Property Office, the disclosure of which is incorporated herein by reference herein in its entirety.

### BACKGROUND

### 1. Field

The disclosure relates to an apparatus and a method for inspecting an inspection target object, and specifically, relate to an apparatus and a method for inspecting a semiconductor.

### 2. Description of Related Art

In order to inspect defects in inspection target objects, such as semiconductors, optical microscopes using objective lenses and electron microscopes (using electron beams and electron lenses) are used. Recently, research and development have been conducted on lens-less microscopes that replace the objective lens role of conventional optical microscopes with computational optics techniques. In a method of using a lens-less microscope, a light source irradiates light onto the sample to obtain a diffraction pattern, and the holographic image is restored to inspect the sample for defects.

Since the method does not use a lens, the resolution of an image acquired by the lens-less microscope is limited by the size of the camera sensor. Further, twin image artifact occurs during holographic image restoration due to the symmetry of the direction of light propagation. In order to overcome the problem of lens-less microscopes described above, a method can be used to obtain multiple images of a sample by moving the light source or the sample horizontally, and then, compositing the images into an image to achieve the effect of taking pictures with smaller pixels, or by moving the sample or a sensor vertically, multiple images of the sample can be obtained and twin image artifacts can be removed by utilizing images with different image quality information.

However, since the methods require that the sample, a light source, or a sensor moves in the vertical direction and/or the horizontal direction, the movement of a driving part to change the position of the sample inevitably causes vibration to occur in the inspection target object, and thus, the accuracy of inspecting defects in the sample is poor.

### SUMMARY

Provided are an inspection apparatus and a method for efficiently inspecting an inspection target object.

The technical aspects to be achieved by example embodiments of the disclosure are not limited to the technical aspects described above, and other technical aspects not described will be apparent to those skilled in the art from the disclosure and the accompanying drawings.

According to an aspect of the disclosure, an inspection method includes: obtaining a plurality of diffraction images of an inspection target object by performing a plurality of lighting cycles in which a plurality of light sources are configured to sequentially irradiate light onto the inspection target object; and obtaining an output image of the inspection target object based on the plurality of diffraction images, wherein for each of the plurality of lighting cycles, the light irradiated to the inspection target object has a different wavelength range.

According to an aspect of the disclosure, an inspection method includes: sequentially irradiating lights, by a plurality of light sources that are individually turned on/off, onto an inspection target object; obtaining a plurality of diffraction images of the inspection target object by a detector configured to receive the lights diffracted from the inspection target object; and obtaining an image of the inspection target object by aligning the plurality of diffraction images based on shift amount information of a diffraction pattern of each of the plurality of diffraction images, and compositing the aligned plurality of diffraction images.

According to an aspect of the disclosure, an inspection method includes: outputting light from a plurality of light sources placed at different positions; irradiating first light having a first wavelength range, second light having a second wavelength range and third light having a third wavelength range; obtaining a plurality of first low resolution diffraction images of an inspection target object by a detector configured to receive the first light diffracted from the inspection target object; obtaining a plurality of second low resolution diffraction images of the inspection target object by the detector configured to receive the second light diffracted from the inspection target object; obtaining a plurality of third low resolution diffraction images of the inspection target object by the detector configured to receive the third light diffracted from the inspection target object; based on shift amount information of a diffraction pattern of each of the first low resolution diffraction images, the second low resolution diffraction images and third low resolution diffraction images, aligning the first low resolution diffraction images, the second low resolution diffraction images and third low resolution diffraction images, and compositing a first high resolution diffraction image from the aligned first low resolution diffraction images, a second high resolution diffraction image from the aligned second low resolution diffraction images, and a third high resolution diffraction image from the aligned third low resolution diffraction images; and obtaining an output image of the inspection target object by calculating a final amplitude and phase based on a difference in diffraction angles between a first wavelength range of the first high resolution diffraction image, a second wavelength range of the second high resolution diffraction image and a third wavelength range of the third high resolution diffraction image, wherein the outputting the light comprises: a first lighting cycle in which the first light output by each of the plurality of light sources being sequentially turned on/off is irradiated to the inspection target object; a second lighting cycle in which the second light output by each of the plurality of light sources being sequentially turned on/off is irradiated to the inspection target object; and a third lighting cycle in which the third light output by each of the plurality of light sources being sequentially turned on/off is irradiated to the inspection target object.

Additional aspects of example embodiments will be set forth in part in the description which follows and, in part, will be apparent from the description, or may be learned by practice of the disclosure.

According to example embodiments, it is possible to obtain high-resolution and high-quality output images for an inspection target object in a state that a light source, the inspection target object and a detector being fixed in positions.

According to example embodiments, it is possible to miniaturize an inspection apparatus, and reduce the maintenance costs of the inspection apparatus.

The effect of the example embodiments are not limited to the above-described effects, and other effects not described would be clearly understood by those skilled in the art from the description of the claims.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram illustrating an inspection apparatus according to an example embodiment;

FIG. 2 is a perspective view of an inspection apparatus according to an example embodiment;

FIG. 3 is a schematic drawing illustrating a light source of FIG. 2;

FIG. 4 is a schematic drawing illustrating a detector of FIG. 2;

FIG. 5 is a flow chart of an inspection method according to an example embodiment;

FIGS. 6 to 12 are drawings for explaining the inspection method of FIG. 5;

FIGS. 13A to 13C illustrate photographs and graphs showing the effects of high-resolution implementation;

FIGS. 14A and 14B illustrate photographs showing the effects of high-quality implementation through phase restoration; and

FIG. 15 is a perspective view schematically illustrating an inspection apparatus according to an example embodiment.

### DETAILED DESCRIPTION

Example embodiments of the disclosure described below can be modified and implemented in various forms. The technical idea of the disclosure is not limited to the example embodiments described below. With regard to the terms used in the example embodiments of the disclosure, except for the cases where the applicant arbitrarily selected and described in detail the meaning thereof in the disclosure, the currently widely used general terms are selected as much as possible while taking into account the function in the disclosure. However, terms may vary depending on the intention of a person skilled in the art to which the disclosure pertains, case law, or the emergence of new technologies. Further, terms and words used in the disclosure and claims should not be construed as limited to their ordinary or dictionary meanings, and the terms and words should be interpreted to include meanings and concepts consistent with the technical idea of the disclosure.

Throughout the disclosure, when a part is described as “comprising” or “including” a component, it does not exclude another component but may further include another component unless otherwise stated. The terms “have,” “may have,” “include,” and “may include” as used herein indicate the presence of corresponding features (for example, elements such as numerical values, functions, operations, or parts), and do not preclude the presence of additional features.

In the disclosure, singular expressions include plural expressions unless the context clearly indicates otherwise. Further, terms “first,” “second” and so on may be used to describe various components. However, the components are not limited by the terms, and the terms may be used for the purpose of distinguishing one component from another. Within the scope of the technical idea of the disclosure, the first component may be named as the second component. Similarly, the second component may also be named the first component. Further, the shape and size of components may be exaggerated to emphasize clear explanation. Further, expressions “upper side,” “lower side,” “upper portion,” “lower portion,” “side” “upper surface” and “lower surface” described below are based on the direction shown in the drawing, and if the direction of the object changes, it may be expressed differently.

The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

Hereinafter, example embodiments of the present invention are described in detail with reference to the attached drawings so that a person having ordinary skill in the art to which the present invention pertains can easily practice the disclosure.

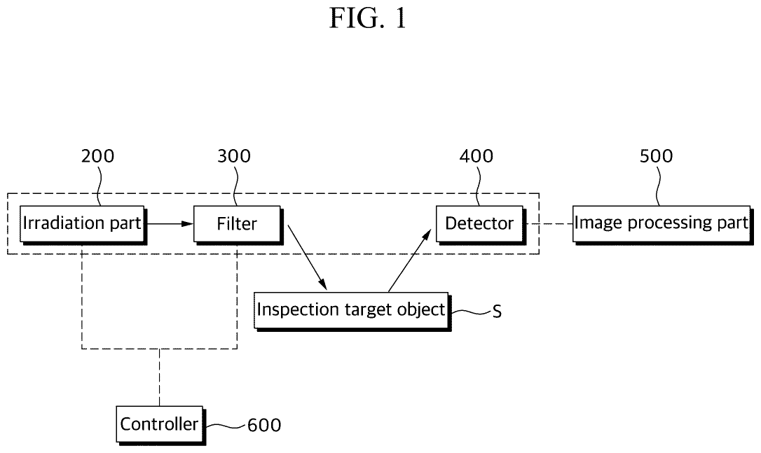

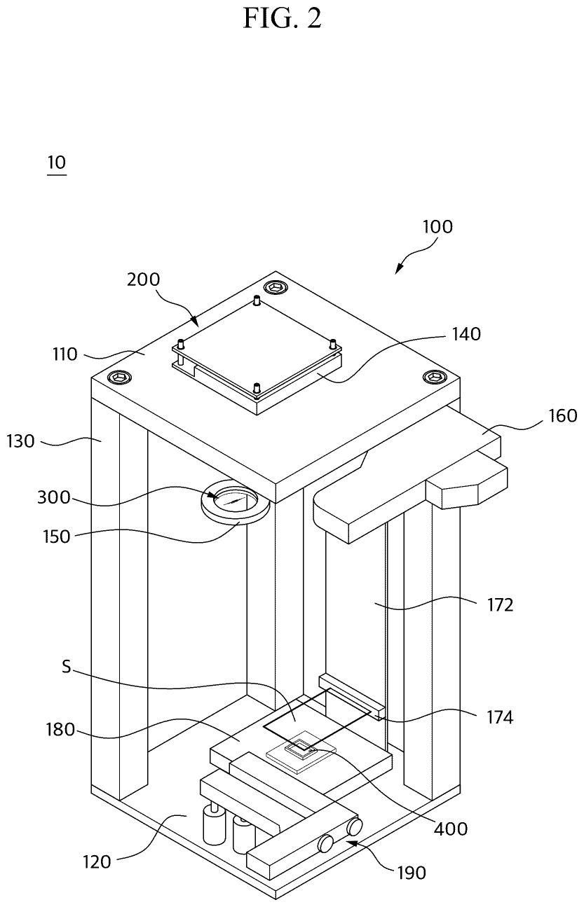

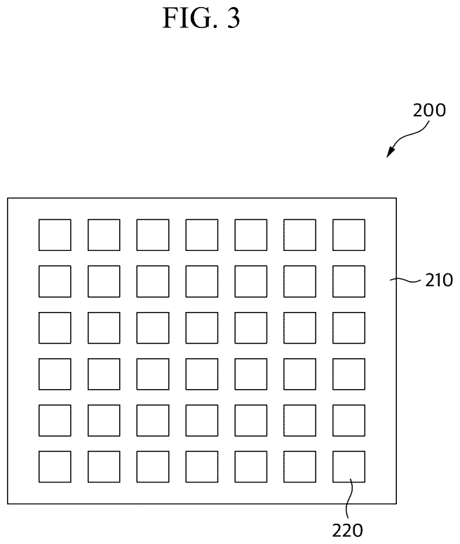

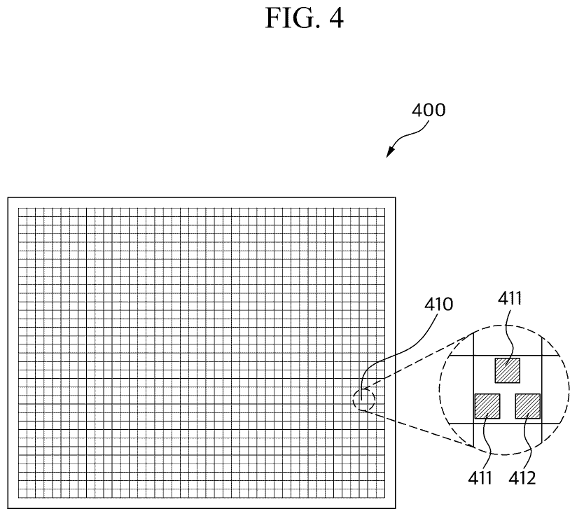

FIG. 1 is a block diagram illustrating an inspection apparatus according to an example embodiment. FIG. 2 is a perspective view of an inspection apparatus according to an example embodiment. FIG. 3 is a schematic drawing illustrating a light source of FIG. 2. FIG. 4 is a schematic drawing illustrating a detector of FIG. 2.

Referring to FIGS. 1 to 4, an inspection apparatus 10 according to example embodiments may inspect an inspection target object S. According to example embodiments, the inspection apparatus 10 may be a lens-less inspection apparatus. In other words, the inspection apparatus 10 may not be equipped with a lens. In example embodiments, the inspection target object S may be a semiconductor. For example, the semiconductor may include a wafer, a glass substrate, a mask, an extreme ultraviolet (EUV) pellicle, and/or a photomask pellicle. Further, the inspection target object S may include a material that allows light to pass through. However, the inspection target object S is not limited to semiconductors. According to example embodiments, the inspection apparatus 10 may also be used to inspect biological samples, medical samples, samples for materials such as metals and polymers, and display samples. As a non-limiting example, the inspection target object S inspected by the inspection apparatus 10 is a semiconductor that transmits light.

According to example embodiments, the inspection apparatus 10 may inspect defects on the inspection target object S. The defects may include particles, physical scratches, and so on that exist on the inspection target object S. Further, the inspection apparatus 10 may inspect the pattern formed on the inspection target object S. Specifically, the inspection apparatus 10 may inspect the uniformity and size of the line width of the pattern formed on the inspection target object S, and the formation location of the pattern.

As shown in FIG. 2, according to example embodiments, the inspection apparatus 10 may include a body 100, an irradiation part 200, a filter 300, a detector 400, an image processing part 500 and a controller 600. The body 100 may have an internal space (or an internal area). The internal space of the body 100 may house (or include) the irradiation part 200, the filter 300 and the detector 400. The body 100, the irradiation part 200, the filter 300 and the detector 400 may be modularized. According to example embodiments, the body 100 may generally have a hexahedral shape, but the technology idea of the disclosure is not limited thereto. The body 100 may include an upper plate 110, a lower plate 120 and a connecting frame 130. According to example embodiments, the upper plate 110 and the lower plate 120 may face each other. The upper plate 110 may be placed on the upper side of the lower plate 120. According to example embodiments, the upper plate 110 and the lower plate 120 may have generally corresponding shapes. For example, the upper plate 110 and the lower plate 120 may have a square shape. Further, the upper plate 110 and the lower plate 120 may have a constant thickness.

According to example embodiments, the connecting frame 130 may have a longitudinal direction perpendicular to the ground. Further, the connecting frame 130 may have a cross-section of a square or circular shape, but the connecting frame 130 is not limited thereto and may be changed into various shapes. The connecting frame 130 may connect the upper plate 110 and the lower plate 120 to each other. Specifically, one end of the connecting frame 130 may be connected to the lower end of the upper plate 110, and the other end of the connecting frame 130 may be connected to the upper end of the lower plate 120. A plurality of connecting frames 130 may be arranged at the corner portions of the upper plate 110 and the lower plate 120. For example, the plurality of connecting frames 130 may be positioned at three out of the four corners of the upper plate 110 and the lower plate 120, respectively. An aligning part 190, described later, may be positioned at the corner positions of the upper plate 110 and the lower plate 120 where the connecting frame 130 is not positioned.

According to example embodiments, the irradiation part 200 may irradiate light towards the inspection target object S. For example, the irradiation part 200 may irradiate light with a continuous spectrum and a wide wavelength range to the inspection target object S.

According to example embodiments, the irradiation part 200 may include a panel 210 and a plurality of light sources 220. According to example embodiments, the panel 210 may be a printed circuit board (PCB) substrate having a generally rectangular shape. The plurality of light sources 220 may be placed on the panel 210. In other words, the plurality of light sources 220 may be arranged on one side of the panel 210. The panel 210 may be supported by a panel holder 140 on top of the upper plate 110. Specifically, the panel holder 140 may be in a shape corresponding to the opening at the top of the upper plate 110, and may protrude from the top of the upper plate 110. The panel holder 140 may support the edge area of the panel 210 in order for the light irradiated from the irradiation part 200 to be transmitted to the inspection target object S and the detector 400 described later. In the edge area of the detector 400, pixels 410, described later, are not placed. Further, the panel 210 may be supported on the panel holder 140 such that one side, on which the plurality of light sources 220 are arranged, faces the inspection target object S and the detector 400.

Accordingly, the light sources 220 placed on the panel 210, the filter 300 described below, the inspection target object S, and the detector 400 may all be positioned on a straight line. The straight line may be perpendicular to the ground, and may be a direction of propagation (the optical axis) of light irradiated by the light sources 220. Additionally, the light that is output from the light sources 220 may be received by the detector 400 while traveling along the optical axis. When the light travels from the light sources 220 to the detector 400, the light may not pass through a lens. The path from the light sources 220 to the detector 400 may be referred to as “lens-less path.”

According to example embodiments, the light sources 220 may output light and irradiate the light onto the inspection target object S. The light is output from the light sources 220 that may be a light emitting diode (LED). The LED emits light within the visible light range. However, the light sources 220 are not limited thereto, and the light that is output and irradiated by the light sources 220 may be a variety of light including ultraviolet (UV) light, infrared (IR) light, extreme ultraviolet (EUV) light and X-ray. With respect to the light that is output and irradiated by the light sources 220, it may be desirable to secure a bandwidth that satisfies a value less than or equal to 5% of the central wavelength. In other words, there are no restrictions on the types and number of wavelengths of light emitted from the light sources 220 according to example embodiments. Further, in example embodiments, the light sources 220 may also output different types of light. Below, example embodiments are given where the light sources 220 is an RGB-LED that irradiates red light, blue light and green light onto the inspection target object S.

According to example embodiments, the light sources 220 may irradiate red light, green light and blue light to illuminate the inspection target object S. Each light source 220 may be a variable LED that integrates multiple LEDs that emit light of different wavelengths to produce red light, green light and blue light into a package of a single light source 220. The color that is output from each light source 220 may be changed by the controller 600 described later. According to example embodiments, the light sources 220 may be arranged on the panel 210 to have a grid or matrix arrangement of rows and columns. However, the light sources 220 is not limited thereto. The light sources 220 may be arranged in a row and placed on the panel 210, may also be placed on the panel 210 to have a honeycomb array arranged in a honeycomb shape, may also be arranged on the panel 210 to have a ring-shaped arrangement, and may be arranged on the panel 210 in an irregular arrangement. However, those are mere example embodiments, and the disclosure is not limited thereto. Further, according to example embodiments, the plurality of light sources 220 may be placed at a certain distance from each other. For example, the plurality of light sources 220 may be positioned at different locations on a virtual plane facing the inspection target object S. According to example embodiments, 42 light sources 220 may be arranged on the panel 210 in an array of 6 rows and 7 columns, but the number and arrangement of the light sources 220 are not limited to these example embodiments. For example, the number of light sources 220 may be N (N is a natural number equal to or greater than 2). However, in the below case, there are 42 light sources 220, arranged in 6 rows and 7 columns on the panel 210. Unlike what is described above, the panel 210 may have a generally spherical shape. In this case, the shape of the panel holder 140 may also correspond to the panel 210, and the light sources 220 may be arranged in a radial shape on the spherical panel 210. In addition thereto, the shape of panel 210 may be modified in various ways.

In example embodiments, the filter 300 may be placed on the optical axis. Further, the filter 300 may be placed between the irradiation part 200 and the inspection target object S. The light irradiated from the above described irradiation part 200 may pass through the filter 300 and be transmitted to the inspection target object S. In example embodiments, the filter 300 may transmit the incident light and adjust the bandwidth of the transmitted light. Further, the filter 300 may contain three color filters. For example, the filter 300 may include three color filters that transmit red light, green light and blue light, respectively. In example embodiments, the filter 300, which transmits red light, may adjust the center wavelength of the light irradiated from the irradiation part 200 to, for example, about 633 nm. The filter 300, which transmits green light, may adjust the center wavelength of the light to, for example, about 532 nm. The filter 300, which transmits blue light, may adjust the center wavelength of the light to, for example, about 473 nm. In other words, the filter 300 may narrow the bandwidth of the transmitted light to pass light to the inspection target object S. As light with a narrow bandwidth is transmitted to the detector 400, which will be described later, the detector 400 may detect light with increased intensity. In the image processing part 500, which will be described later, it may be easier to restore the phase of the diffraction image and output the reconstructed image with high resolution and high quality.

In example embodiments, the filter 300 may be supported by a filter holder 150 installed on the connecting frame. The filter holder 150 may include a driving part 160 including a filter wheel and a motor. The filter wheel has a generally circular disk shape and may support each of the three color filters included in the filter 300. Each color filter may be placed at 120-degree intervals on the filter wheel. Further, a hole connected to the motor shaft of the driving part 160 may be in the center of the filter wheel, and as the motor drives, the position of each color filter placed on the filter wheel may be changed. The driving part 160 may be controlled by the controller 600, which will be described later.

In example embodiments, the filter 300, which transmits red light according to the driving of the motor, may be placed on the optical axis. Accordingly, the bandwidth of the light irradiated from the irradiation part 200 may be adjusted to, for example, about 633 nm. Further, the filter 300 that transmits green light or blue light according to (or based on) the motor operation of the driving part 160 is placed on the optical axis in order for each bandwidth of the light emitted from the irradiation part 200 to be adjusted to, for example, about 532 nm or 473 nm.

According to example embodiments, the inspection target object S may be supported by a sample holder 174. The sample holder 174 may be coupled to a vertical plate 172 formed on one side of the body 100. Specifically, the top of the vertical plate 172 may be connected to the bottom of the upper plate 110, and the bottom of the vertical plate 172 may be connected to the top of the lower plate 120. Further, the vertical plate 172 may be placed between the connecting frames 130. According to example embodiments, the sample holder 174 may be coupled to the inner side of the vertical plate 172 to be fixed in a position. For example, the sample holder 174 may be a clamp (for example, a C-clamp, a bar-clamp and so on) that mechanically supports one side of the inspection target object S. However, the sample holder 174 is not limited thereto. The sample holder 174 may support both sides of the inspection target object S, and may include various known devices that may support the inspection target object S in various other ways. According to example embodiments, the inspection target object S may be supported by the sample holder 174 and positioned on the optical axis. The inspection target object S may be placed between the filter 300 and the detector 400. Further, between the filter 300 and the detector 400, the inspection target object S may be placed in a position relatively adjacent to the detector 400.

According to example embodiments, the detector 400 may be placed on the optical axis. More specifically, the detector 400 may be placed in a straight line with the irradiation part 200 described above, more specifically, in a straight line with the light sources 220, the filter 300, and the inspection target object S. In an embodiment, the detector 400 may be placed on the lower side of the inspection target object S. Accordingly, the detector 400 and the inspection target object S may be placed facing each other. Further, the detector 400 may be placed on a stage 180. The stage 180 may be a chuck that may support the detector 400, but is not limited thereto. Further, the position of the stage 180 may be fixed. Accordingly, the position of the detector 400 placed on the stage 180 may also be fixed.

However, in the process of changing the size of the inspection target object S or adjusting the alignment of the optical axis, the position of the stage 180 may change. Specifically, the position of the stage 180 may be finely adjusted by the aligning part 190 connected to the lower plate 120 of the body 100. However, when the inspection target object S is inspected, the positions of the stage 180 and the detector 400 placed on the stage 180 are fixed.

According to example embodiments, the detector 400 may receive light that passed through the inspection target object S. Further, the detector 400 may receive the light diffracted by a defect or a pattern on the inspection target object S (hereinafter, referred to as “diffracted light”). According to example embodiments, the detector 400 may obtain a diffraction image by receiving transmitted light and diffracted light. The diffraction image may include the amplitude of the diffracted light, the intensity according to the amplitude, and phase information. Further, the diffraction image may include both video and photography.

According to example embodiments, the detector 400 includes a plurality of detecting elements, such as a plurality of pixels 410, arranged in a two-dimensional grid shape. Each pixel 410 may detect the light that the pixel 410 receives, the detector 400 converts the light into electrical signals and obtain a diffraction image. Further, each pixel 410 may include a plurality of sub pixels (a first sub pixel 411, a second sub pixel 412 and a third sub pixel 413). In example embodiments, the pixel 410 may include three sub pixels which are the first sub pixel 411, the second sub pixel 412 and the third sub pixel 413. Specifically, the pixel 410 may include the first sub pixel 411 that receives light having a first wavelength range, the second sub pixel 412 that receives light having a second wavelength range, and the third sub pixel 413 that receives light having a third wavelength range. For example, the first wavelength range may be about 620 nm to 750 nm. The second wavelength range may be about 495 nm to 570 nm. The third wavelength range may be about 450 nm to 495 nm. In other words, the first sub pixel 411 may receive red light and convert the red light into an electrical signal, the second sub pixel 412 may receive green light and convert the green light into an electrical signal, and the third sub pixel 413 may receive blue light and convert the blue light into an electrical signal. However, the disclosure is not limited thereto. In an embodiment, each of the plurality of pixels 410 may include a plurality of sub pixels corresponding to the type, wavelength range, or color of light that is output and irradiated by the various light sources 220. According to example embodiments, the detector 400 may be an image sensor such as a charge-coupled device (CCD) and a complementary metal-oxide-semiconductor (CMOS). As described above, the light (that is output and irradiated by the light sources 220) is provided in the EUV light, X-ray and so on, the detector 400 may be a high-resolution CCD camera capable of detecting short-wavelength light from the EUV light to X-ray.

According to example embodiments, the image processing part 500 may reconstruct the diffraction image obtained from the detector 400 to obtain a final output image of the inspection target object S. The reconstruction of the diffraction image may include high-resolution implementation for diffraction images, and high-quality implementation based on phase restoration. The reconstruction of the diffraction image may be implemented by first reconstruction processing and secondary reconstruction processing, which will be described later. For example, the first reconstruction process may be performed automatically by the first reconstruction algorithm, and the second reconstruction process may be performed automatically by the second reconstruction algorithm (hereinafter, “reconstruction algorithm”). For example, when information about the diffraction image from the detector 400 is input to the image processing part 500, the image processing part 500 may obtain a final output image for which the high-resolution and the high-quality implementation is automatically completed with respect to the diffraction image through a program with a built-in reconstruction algorithm. Further, the image processing part 500 may be a neural network model trained with the process in which diffraction images are processed using reconstruction algorithms. For example, the image processing part 500 may be implemented with at least one of graphics processing unit (GPU), central processing unit (CPU), an artificial intelligence (AI) accelerator and neural processing unit (NPU). The detailed method of obtaining an output image from a diffraction image by the image processing part 500 will be described later.

According to example embodiments, the controller 600 may control components in inspection apparatus 10. The controller 600 may be connected wirelessly or wired to components included in the inspection apparatus 10. The controller 600 may include a process controller including a microprocessor (computer) that executes control, a user interface having a keyboard through which an operator can perform command input operations to manage the device, and a display panel that visualizes the operating status of the device, a control program for executing the device under the control of the process controller, and memory medium for storing such programs. The user interface and storage medium may be connected to the process controller.

According to example embodiments, the controller 600 may control the irradiation part 200 and the driving part 160. Specifically, the controller 600 may change the color of the light that is output and irradiated from the light sources 220 of the irradiation part 200. Further, the controller 600 may control the light sources 220 to be turned on/off. For example, the controller 600 may control the light sources 220 in order for each of the 42 light sources 220 to sequentially output and irradiate the red light, then the green light and finally the blue light. However, the order is a mere example embodiment, and the order in which the red light, the green light and the blue light is output and irradiated may be changed in various combinations.

In addition, when classifying the 42 light sources 220 into light source 1 to light source 42, it may be controlled, for example, by the controller 600 that the light source 1 to the light source 42 output and irradiate red light, but the light source 1 through the light source 42 do not output or irradiate light at the same time, instead the light source 1 to the light source 42 individually output and irradiate light at on/off intervals. The order in which light is output and irradiated may be random. The control is similarly applied when the light sources 220 output and irradiate green light or blue light. In other words, the controller 600 may control the light sources 220 to sequentially turn on/off each of the red light, the greenlight, and the blue light as many as the number of light sources 220.

In example embodiments, the controller 600 may control the driving part 160 that changes the position of the filter 300. Specifically, the controller 600 may change the position of the filter 300 by controlling the operation of the motor of the driving part 160. Accordingly, the filter 300, which transmits the red light, the green light, or the blue light, may be placed on the optical axis. For example, when the light sources 220 are controlled to output the red light, the controller 600 may control the driving part 160 in order for the filter 300, which transmits the red light and may adjust the bandwidth thereof to, for example, about 633 nm, to be placed on the optical axis. Further, when the light sources 220 are controlled to output the green light, the controller 600 may place the filter 300, which transmits the green light and may adjust the bandwidth thereof to, for example, about 532 nm, on the optical axis. Further, when the light sources 220 are controlled to output the blue light, the controller 600 may place the filter 300, which transmits the blue light and may adjust the bandwidth thereof to, for example, about 473 nm, on the optical axis.

Unlike the above-mentioned example, In an embodiment, inspection apparatus 10 may not be separately equipped with the image processing part 500. In this case, a series of processes processed by the image processing part 500 may be processed by the detector 400 or the controller 600. However, below, the cases where the inspection apparatus 10 includes the image processing part 500 are described as example embodiments.

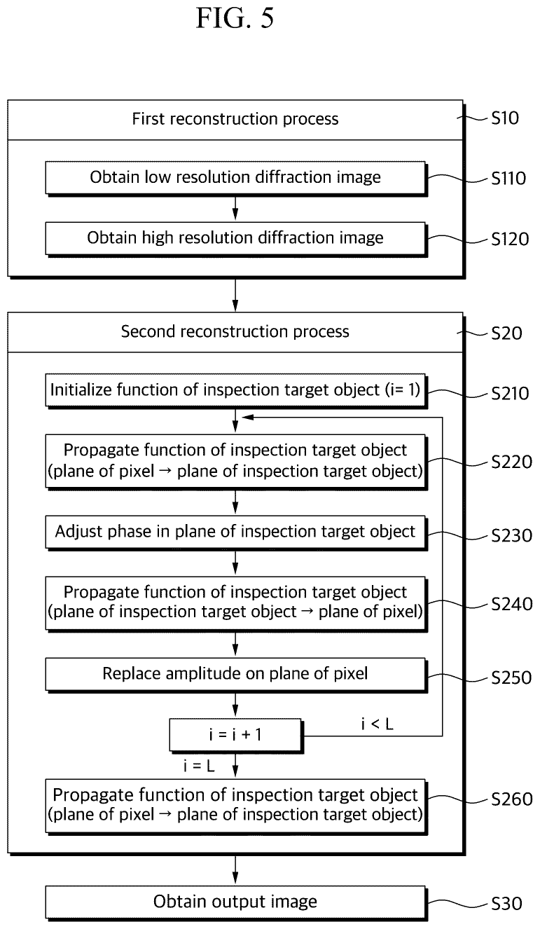

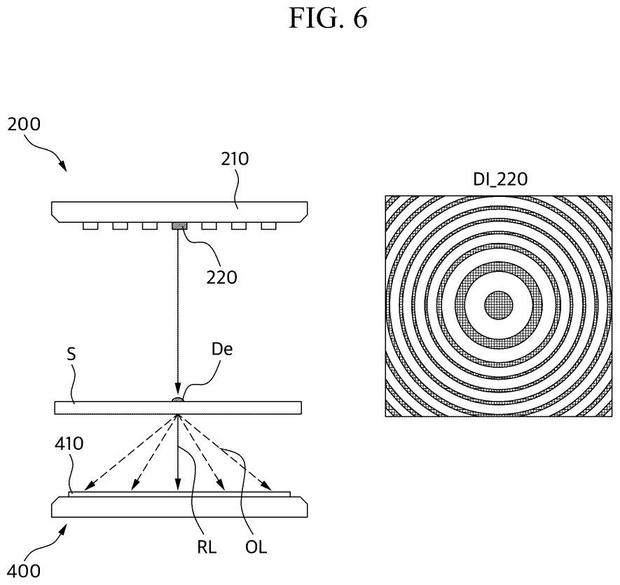

FIG. 5 is a flow chart of an inspection method according to an example embodiment. FIGS. 6 to 12 are drawings for explaining the inspection method of FIG. 5. In FIGS. 6 to 8 and FIG. 11, the filter 300 described above is omitted.

Below, example embodiments of the method for inspecting a semiconductor that is the inspection target object S by using the inspection apparatus 10 are described above with reference to FIGS. 1 to 4. Further, the inspection method described below may be performed by processing of the image processing part 500 and control of the controller 600. Specifically, processing the diffraction image described below may be performed by the image processing part 500, and on/off control of the light sources 220 and position control of the filter 300 by the driving part 160 may be performed by the controller 600. Hereinafter, an inspection method according to some embodiments will be described with reference to FIGS. 5 to 12, and the method is described by referencing the same reference numerals used in FIGS. 1 to 4.

According to example embodiments, the inspection method may include first reconstruction process in operation S10 and second reconstruction process in operation S20. In an embodiment, the first reconstruction process in operation S10 and the second reconstruction process in operation S20 may be performed in time series order.

According to example embodiments, in the first reconstruction process in operation S10, a diffraction image obtained from the detector 400 is first reconstructed in the image processing part 500 and a high resolution diffraction image of the inspection target object S may be obtained.

In example embodiments, the first reconstruction process in operation S10 may include obtaining a low resolution diffraction image in operation S110 and obtaining a high resolution diffraction image in operation S120.

As illustrated in FIG. 6, in example embodiments, in operation S110 where the low resolution diffraction image is obtained, the light source 220 may irradiate light to the inspection target object S. The filter 300 may be located in the direction of light travel (in other words, the optical axis). As described above, the filter 300, the inspection target object S and the detector 400 are all located on the optical axis, and thus, the light irradiated from the light sources 220 may pass through the filter 300 and the inspection target object S, and may be received by the detector 400, that is, the pixel 410. If a pattern is formed or a ‘defect De’ exists on the inspection target object S, some of the light irradiated from the light sources 220 may be diffracted by the defect De, and form ‘diffracted light OL.’ Conversely, some of the light emitted from the light sources 220 may directly pass through the inspection target object S. Reference light RL, which directly passes through the inspection target object S, and the diffracted light OL diffracted by the defect De may all be received by the detector 400. The reference light RL and the diffracted light OL received by the detector 400 overlap on the pixel 410, causing interference due to phase difference to generate a diffraction pattern. The detector 400 may obtain a diffraction image DI_220 by recording the generated diffraction pattern. The diffraction image recorded in the detector 400 may include the amplitude of the diffracted light OL, intensity according to the amplitude, and phase information. The reference light RL and the diffracted light OL illustrated in FIG. 6 may only be partially illustrated for convenience of explanation. In reality, more diffracted light than illustrated may be included.

Further, in operation S110 where the low resolution diffraction image is obtained, the above described diffraction image DI_220 obtaining process may be repeated multiple times. Specifically, light may be irradiated to the inspection target object S sequentially at time intervals for each light source 220. For example, when there are the 42 light sources 220, each of the 42 light sources 220 may be turned on/off at time intervals, and individually radiate light to the inspection target object S. In other words, performed may be a lighting cycle in which light is sequentially output from the light sources 220 as many as the number of light sources 220, and at this time, the order of turning on/off the light source 220 may be stored in advance in the controller 600 described above. The lighting cycle may be performed for each color of light. For example, red light may be sequentially irradiated from each of the 42 light sources 220 to the inspection target object S 42 times (for example, a first lighting cycle), after then, green light from each of the 42 light sources 220 may be sequentially illuminated 42 times on the inspection target object S (for example, a second lighting cycle), and subsequently, blue light from each of the 42 light sources 220 may be sequentially irradiated onto the inspection target object S 42 times (for example, a third lighting cycle). In other words, in operation S110 where a low resolution diffraction image is obtained, the lighting cycle may be performed three times.

However, the above example embodiments are for illustrative purposes only. For example, the order in which red light, green light and blue light are irradiated may be combined in many different ways, and the number of lighting cycles may vary depending on the number of colors that are output and irradiated by the light sources 220. In addition, described is the example embodiment that within a single lighting cycle, light of the same color is irradiated onto the inspection target object S, but the disclosure is not limited thereto. For example, within a single lighting cycle, light of different colors may be combined and irradiated onto the inspection target object S. The controller 600 may remember the color of light emitted from a specific light source 220 and the order in which the light source 220 was turned on/off, and transmit information thereof to the image processing part 500 during the process of reconstructing the diffraction image described below. In example embodiments, the 42 light sources 220, 42 red lights, 42 green lights, and 42 blue lights are sequentially irradiated onto the inspection target object S.

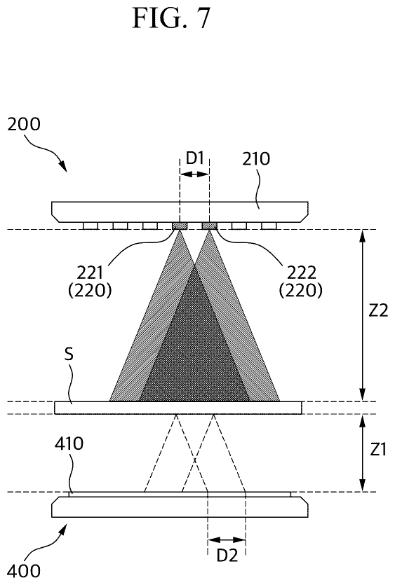

In operation S110 of obtaining the low resolution diffraction image, after going through three lighting cycles in which the light sources 220 irradiate light towards the inspection target object S, 42 diffraction images for red light, 42 diffraction images for green light, and 42 diffraction images for blue light may be obtained. Each diffraction image obtained in each lighting cycle may have different phases, intensities, and so on. Further, each of the diffraction images obtained in each lighting cycle may be a low-resolution image. Specifically, as illustrated in FIG. 7, the light sources 220 may include a first light source 221 and a second light source 222. The first light source 221 and the second light source 222 may be light sources positioned adjacent to each other. For example, the first light source 221 and the second light source 222 may be positioned horizontally to the ground, and the first light source 221 may be placed a distance D1 from the second light source 222. The first distance D1 may be understood as the straight-line distance on the horizontal plane between the center of the first light source 221 and the center of the second light source 222. The vertical distance from the lower surface of the inspection target object S to the upper surface of the pixel 410 may be defined as a first vertical distance Z1. The vertical distance from the light source 220 to the upper surface of the inspection target object S may be defined as a second vertical distance Z2. In other words, the second vertical distance Z2 may be understood as a given distance from the light source 220 to the inspection target object S. When the second light source 222 is turned on/off after the first light source 221 is turned on/off, light irradiated from the first light source 221 and the second light source 222 respectively may pass through the inspection target object S and received by the multiple pixels 410. The diffraction pattern generated by the second light source 222 may be shifted by a second distance D2 relative to the diffraction pattern generated by the first light source 221 on the plane (the upper surface) of the pixel 410.

The second distance D2 may be determined by [Equation 1] below:

$$\frac{D 1}{D 2} = \frac{Z 1}{Z 2} \qquad [ Equation 1 ]$$

For example, when the light source 220 is located at a distance five hundreds (500) times farther from the plane of the inspection target object S than the distance from the plane of the pixel 410 of the detector 400, the ratio of the first vertical distance Z1 to the second vertical distance Z2 may be approximately 500:1. Further, when the straight-line distance on the horizontal plane between the center of the first light source 221 and the center of the second light source 222 (the first distance D1) is 4 mm, if the second light source 222 is turned on/off after the first light source 221 is turned on/off, the same result may be obtained as if the light irradiated on the inspection target object S is moved the first distance D1 on the horizontal plane. In this case, the diffraction pattern generated by the second light source 222 may be shifted by, for example, about 8 μm, which is the second distance D2, relative to the diffraction pattern generated by the first light source 221. In other words, the shift amount of the diffraction pattern, which is the second distance D2, may be determined based on the first vertical distance Z1, the second vertical distance Z2 and the first distance D1. As the gap between the inspection target object S and the detector 400 becomes narrower and as the number of the light sources 220 becomes greater, the shift in the diffraction pattern may increase. According to the above described example embodiments, there may be the effect as if the diffraction pattern shifts in the plane of the pixel 410 of the detector 400 depending on the position of the light source 220, which is turned on/off at time intervals. Without moving the position of the irradiation part 200, the detector 400 may obtain a plurality of low resolution diffraction images with different diffraction patterns.

In the process for calculating the shift amount of the above described diffraction pattern, the reference position for calculating the first distance D1 is the center of the light source that was turned on/off just before, and is only an example embodiment.

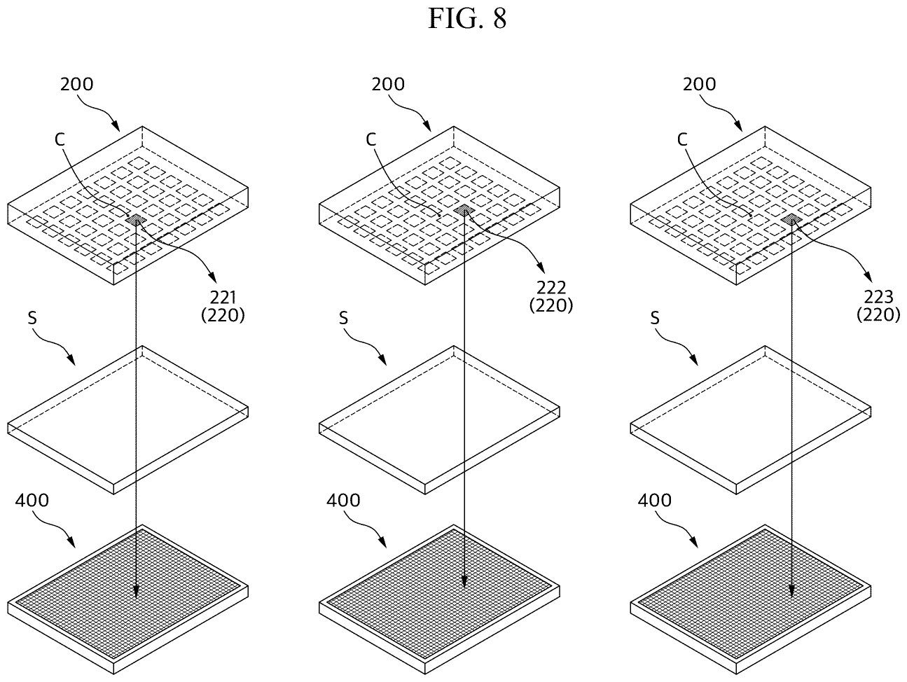

According to example embodiments, as illustrated in FIG. 8, the straight-line distance in the horizontal plane from the irradiation part 200, for example, a center C of the panel 210 to the center of the light source 220 turned on/off may be the first distance D1. In other words, in example embodiments, the reference position for calculating the first distance D1 may be the center C of the panel 210. The first distance D1 may include a vector value on the horizontal plane. However, in another example embodiment in which the light sources 220 are arranged radially on the spherical panel 210, the first distance D1 may also include vector values in the vertical and horizontal planes.

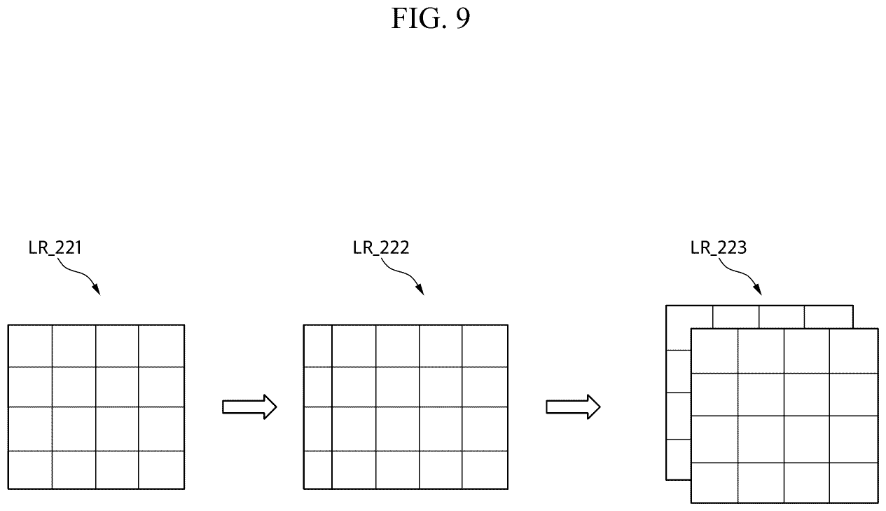

As illustrated in FIGS. 8 and 9, the detector 400 may include each of a low resolution diffraction image LR_221 with a diffraction pattern for the first light source 221, a low resolution diffraction image LR_222 with a diffraction pattern for the second light source 222, and a low resolution diffraction image LR_223 with a diffraction pattern for a third light source 223. Each of the low resolution diffraction image LR_221, the low resolution diffraction image LR_222 and the low resolution diffraction image LR_223 may include the amplitude of the diffracted light, intensity according to the amplitude, and/or phase information. The detector 400 may have record on: information included in the low resolution diffraction image LR_221, the low resolution diffraction image LR_222 and the low resolution diffraction image LR_223; information about the first light source 221, the second light source 222 and the third light source 223 corresponding to each of the low resolution diffraction image LR_221, the low resolution diffraction image LR_222 and the low resolution diffraction image LR_223; and the distance from the center of each of the first light source 221, the second light source 222 and the third light source 223 to the center C of the panel 210, that is, information about the first distance D1 of each of the low resolution diffraction image LR_221, the low resolution diffraction image LR_222 and the low resolution diffraction image LR_223. Accordingly, when recorded, the information about shift amount (for example, the second distance D2) the diffraction pattern included in each of the low resolution diffraction image LR_221, the low resolution diffraction image LR_222 and the low resolution diffraction image LR_223 corresponds to each of the first light source 221, the second light source 222 and the third light source 223 that irradiated the light.

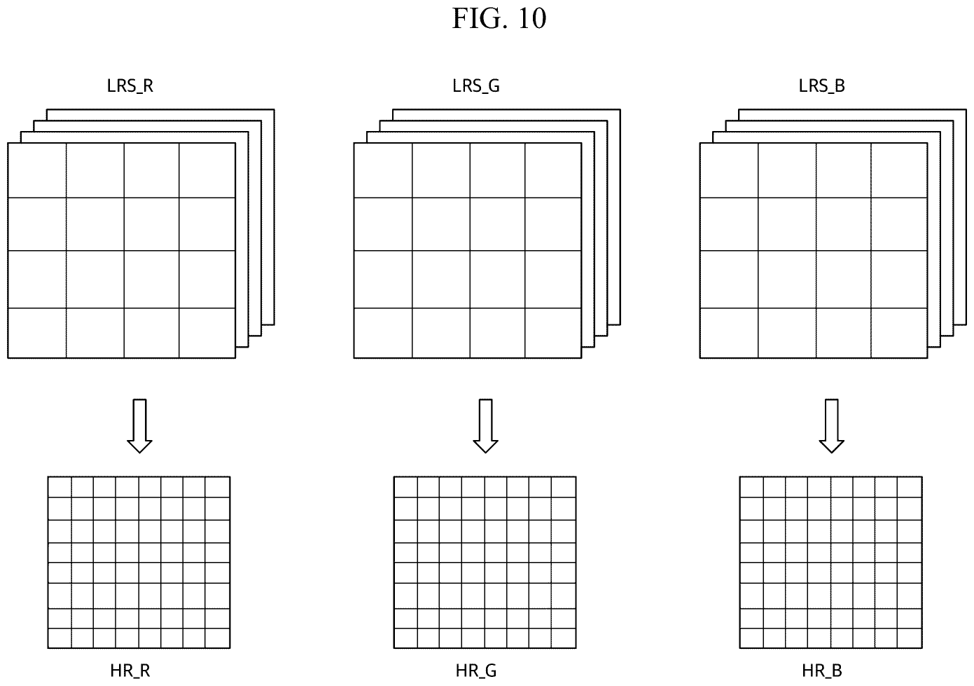

FIG. 10 illustrates that each low resolution diffraction image stack contains three low resolution diffraction images. According to example embodiments, as illustrated in FIG. 10, the detector 400 may obtain 42 low resolution diffraction images for light of the same color (or wavelength range). For example, when red light is sequentially output and irradiated from each of the 42 light sources 220, the detector 400 may obtain 42 low resolution diffraction images for red light, that is, a red low resolution diffraction image stack LRS_R. In other words, 42 low resolution diffraction images for red light may be collected to obtain the red low resolution diffraction image stack LRS_R. Further, the detector 400 may obtain each of a green low resolution diffraction image stack LRS_G that is a set of 42 low resolution diffraction images for green light, and a blue low resolution diffraction image stack LRS_B that is a set of 42 low resolution diffraction images for blue light.

According to example embodiments, in operation S120 of obtaining a high resolution diffraction image, performed may be high-resolution restoration on each of the red low resolution diffraction image stack LRS_R, the green low resolution diffraction image stack LRS_G, the blue low resolution diffraction image stack LRS_B that are obtained in the operation S110 in which the low resolution diffraction image is obtained. Specifically, a high resolution diffraction image may be obtained by aligning each diffraction image included in the low resolution diffraction image stack obtained in operation S110 where the low resolution diffraction image is obtained to a reference position, and compositing each aligned diffraction image. For example, alignment may be performed on each low resolution diffraction image using the shift amount information (for example, the second distance D2) of the diffraction pattern contained in each of the 42 low resolution diffraction images included in the red low resolution diffraction image stack LRS_R. In other words, by performing Fourier transform, by collecting the shift amount information of the diffraction pattern included in each low resolution diffraction image, the shift amount of the relative diffraction pattern of each low resolution diffraction image may be calculated. Accordingly, each low resolution diffraction image may be aligned. The mechanism may be performed equally for the green low resolution diffraction image stack LRS_G and the blue low resolution diffraction image stack LRS_B. In example embodiments, composited may be low resolution diffraction images included in each of the red low resolution diffraction image stack LRS_R, the green low resolution diffraction image stack LRS_G and the blue low resolution diffraction image stack LRS_B for which alignment is complete. For example, low resolution diffraction images may be synthesized using the pixel super resolution (PSR) technique. The composition may be performed individually for each of the red low resolution diffraction image stack LRS_R, the green low resolution diffraction image stack LRS_G, and the blue low resolution diffraction image stack LRS_B. For example, 42 diffraction images included in the red low resolution diffraction image stack LRS_R may be composited to obtain a red high resolution diffraction image HR_R. Further, a green high resolution diffraction image HR_G may be obtained by compositing 42 diffraction images included in the green low resolution diffraction image stack LRS_G, and a blue high resolution diffraction image HR_B may be obtained by compositing 42 diffraction images included in the blue low resolution diffraction image stack LRS_B.

In general, for the PSR technique, a plurality of images may be obtained when a light source, a test sample, and/or a detector are moved horizontally, and a high resolution image may be obtained by compositing the obtained images. In other words, for the PSR technique, horizontal movement of the light source is required. However, according to example embodiments, without changing positions of the irradiation part 200, the inspection target object S and the detector 400, by changing the on/off order and a position of the light source 220, the same effect of moving the light source 220 horizontally may be obtained. Accordingly, by aligning and compositing low resolution diffraction images, the red high resolution diffraction image HR_R, the green high resolution diffraction image HR_G, and the blue high resolution diffraction image HR_B may be obtained. As such, when a certain inspection is performed on the inspection target object S in the state that the positions of the irradiation part 200, the inspection target object S and the detector 400 are all fixed, various factors such as vibration applied to the inspection target object S may be blocked, and thus the reliability of the inspection and the durability of the inspection apparatus 10 may be improved.

In addition, according to the PSR technique, in order to improve the image resolution by M times, more than M2 number of diffraction images (where M2 is a natural number) may be required. According to example embodiments described above, without changing the position of the light source 220, there is the effect of changing the position of the light source 220 by the number of light sources 220, and a number of low resolution diffraction images corresponding to the number of light sources 220 having different diffraction patterns may be obtained. Thus, the resolution of the diffraction image may be varied according to requirements with a simple design change to reduce or increase the number of light sources.

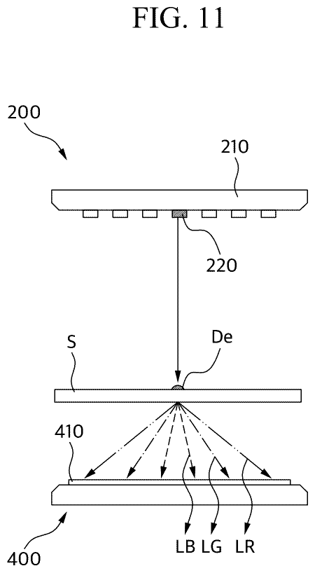

According to example embodiments, in operation S20, the second reconstruction process may obtain a high-quality diffraction image of the inspection target object S by secondarily reconstructing the red high resolution diffraction image HR_R, the green high resolution diffraction image HR_G, the blue high resolution diffraction image HR_B obtained by first reconstruction. In example embodiments, in operation S20 that is the second reconstruction process, an output image, which is a high-resolution and high-quality image of the inspection target object S, may be obtained by using the difference in diffraction angles of the obtained red high resolution diffraction image HR_R, the obtained green high resolution diffraction image HR_G, and obtained the blue high resolution diffraction image HR_B according to wavelength. Specifically, as illustrated in FIG. 11, the light irradiated from one light source 220 and irradiated onto the inspection target object S may be diffracted by the defect De on the inspection target object S when passing through the inspection target object S. In this case, depending on the color of the light irradiated by the light source 220, that is, the wavelength value of the light, the diffraction patterns such as diffraction angle, diffraction pattern and so on may be different. For example, red light LR may have a relatively larger diffraction angle than green light GR. Further, the green light GR may have a relatively larger diffraction angle than blue light BR.

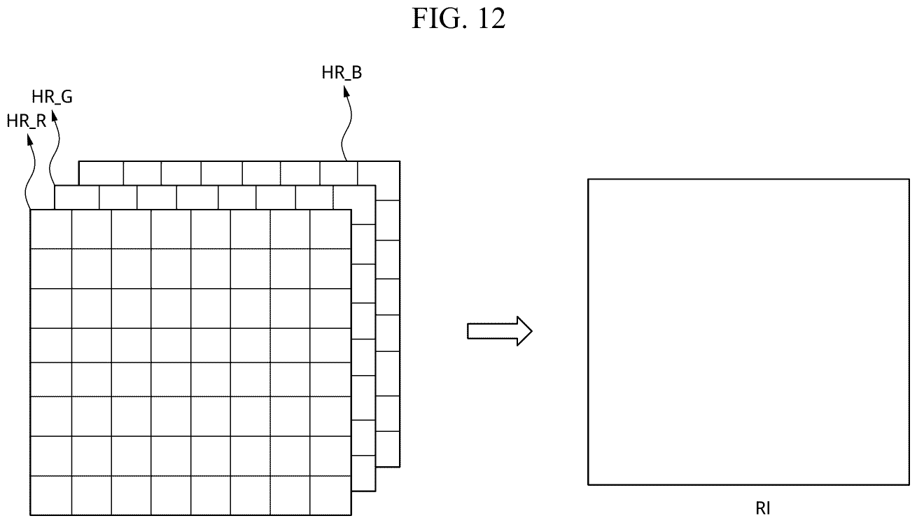

As illustrated in FIGS. 11 and 12, in operation S20 which is the second reconstruction process, a final output image RI for the inspection target object S may be obtained by estimating complex amplitude including the amplitude of the inspection target object S due to the difference in diffraction angles at different wavelengths in the red high resolution diffraction image HR_R, the green high resolution diffraction image HR_G and the blue high resolution diffraction image HR_B and phase information, by calculating the final amplitude and phase by inverse Fourier transforming the complex amplitude, and by assigning a reconstructed image for the red high resolution diffraction image HR_R, a reconstructed image for the green high resolution diffraction image HR_G, and a reconstructed image for the blue high resolution diffraction image HR_B to each color channel.

For example, in operation S20 which is the second reconstruction process, the red high resolution diffraction image HR_R, the green high resolution diffraction image HR_G and the blue high resolution diffraction image HR_B may be processed by using the multi-wavelength phase retrieval (MWPR) technique. Further, in example embodiments, with regard to the diffraction patterns that appear differently due to different diffraction angles and diffraction patterns according to different wavelengths of the red high resolution diffraction image HR_R, the green high resolution diffraction image HR_G, and the blue high resolution diffraction image HR_B, the wavefront may be decomposed into an angular spectrum, each spectral component may be propagated independently and then re-composited in order for the transmitted wavefront to be calculated with the angular spectrum method technique.

Specifically, according to example embodiments, operation S20 which is the second reconstruction process may start with operation S210 which is initializing the function (an object function) of the inspection target object S. Here, i, which indicates the number of times in the sequence, may have the value 1. The initial amplitude of the function of the inspection target object S in the plane of the pixel 410 of the detector 400 may be assigned as the square root of the intensity of the high resolution diffraction image. For example, the initial amplitude of the function of the inspection target object S in the plane of the pixel 410 may be assigned as the square root of the intensity of the red high resolution diffraction image HR_R obtained in operation S10 which is the first reconstruction process. In addition, an initial phase of the inspection target object S on the plane of the pixel 410 may be set to 0.

As described below, operation S220 to operation S250 may be repeated using the object function of the above initialized inspection target object S. Specifically, in operation S220, the function of the current inspection target object S may be propagated from the plane of the pixel 410 to the plane of the inspection target object S. As a result, the function of the inspection target object S may be obtained in the plane of the inspection target object S. After then, in operation S230, the phase in the plane of the inspection target object S may be adjusted according to Equation 2 below in order to be corresponding to the wavelength of the light (for example, red light) emitted from the light source 220. In other words, the wavefront change according to the wavelength of the red light irradiated from the light source 220 may be corrected according to [Equation 2] below:

$${φ}_{n + 1} = \frac{{λ}_{n}}{{λ}_{n + 1}} {φ}_{n} \qquad [ Equation 2 ]$$

In above [Equation 2], λ may indicate wavelength, n may indicate the current operation, and φₙ may indicate the relative phase delay in λₙ. In other words, with Equation 2, the phase at the current wavelength may be adjusted to correspond to the next wavelength, and this allows obtaining the phase in the plane of the inspection target object S, adjusted to correspond to the following wavelengths.

Further, in operation S240, the function of the adjusted inspection target object S may be propagated back from the plane of the inspection target object S to the plane of the pixel 410. Through this, the function of the inspection target object S on the plane of the pixel 410 may be obtained. In other words, this may be a process of calculating what diffraction pattern the function of the adjusted inspection target object S would produce in the plane of the pixel 410. Then, in operation S250, the amplitude on the plane of the pixel 410 may be replaced. Specifically, the amplitude value on the plane of the pixel 410 may be assigned to the square root of the intensity of the red high resolution diffraction image HR_R described above. The phase may not change. Operation S220 to operation S250 may be repeated multiple times. According to example embodiments, L may be 60.

In other words, operation S220 to operation S250 may be repeated 60 times, but the disclosure is not limited thereto. Due to such repetitions, the function of the inspection target object S may be computed incrementally, and the final function of the inspection target object S may be obtained. Further, after operation S220 to operation S250 are repeated L times, when the final function of the inspection target object S is obtained, the final complex amplitude of the inspection target object S may be obtained by propagating the final function of the inspection target object S onto the plane of the inspection target object S in operation S260. For example, when operation S220 to operation S250 for the red high resolution diffraction image HR_R are repeated L times, operation S210 to operation S250 described above may be repeated L times for the green high resolution diffraction image HR_G and L times for the blue high resolution diffraction image HR_B. The final complex amplitude may be obtained by propagating the final function of the inspection target object S obtained at each operation onto the plane of the inspection target object S. As described above, based on the final complex amplitude that is obtained from the red high resolution diffraction image HR_R, the green high resolution diffraction image HR_G and the blue high resolution diffraction image HR_B, the image of the inspection target object S may be reconstructed, and each reconstructed image may be assigned to a color channel to obtain the final output image RI for the inspection target object S in operation S30.

According to the example embodiment described above, there may be no need to move the irradiation part 200, the inspection target object S, and/or the detector 400 in a direction perpendicular to the ground to implement phase restoration for the inspection target object S. In other words, the output image RI for the inspection target object S whose phase is restored may be obtained using the red high resolution diffraction image HR_R, the green high resolution diffraction image HR_G and the blue high resolution diffraction image HR_B that are obtained in operation S10 which is the first reconstruction process. Accordingly, in the process of inspecting the inspection target object S, blocked may be factors such as vibration applied to the inspection target object S due to changes in the position of the components or the operation of the device. Thus, the reliability of the inspection and the durability of the inspection apparatus 10 may be improved.

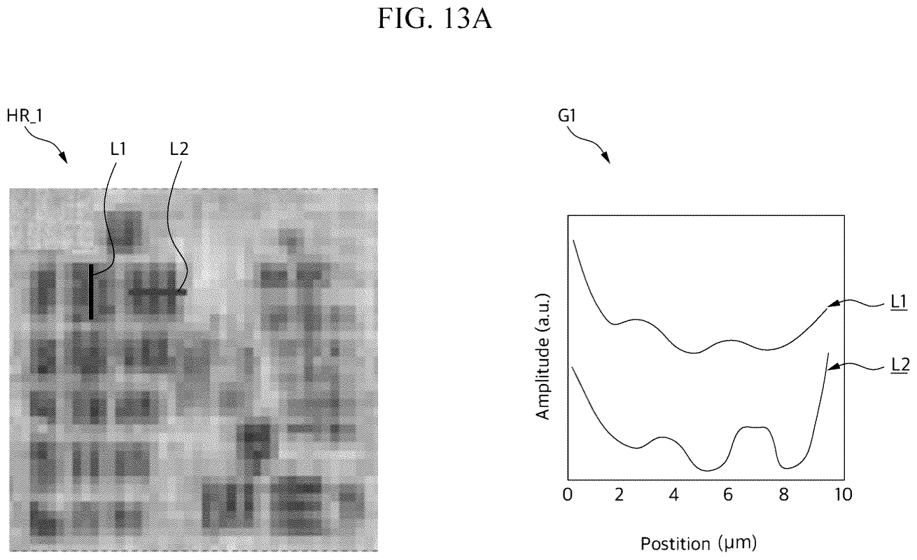

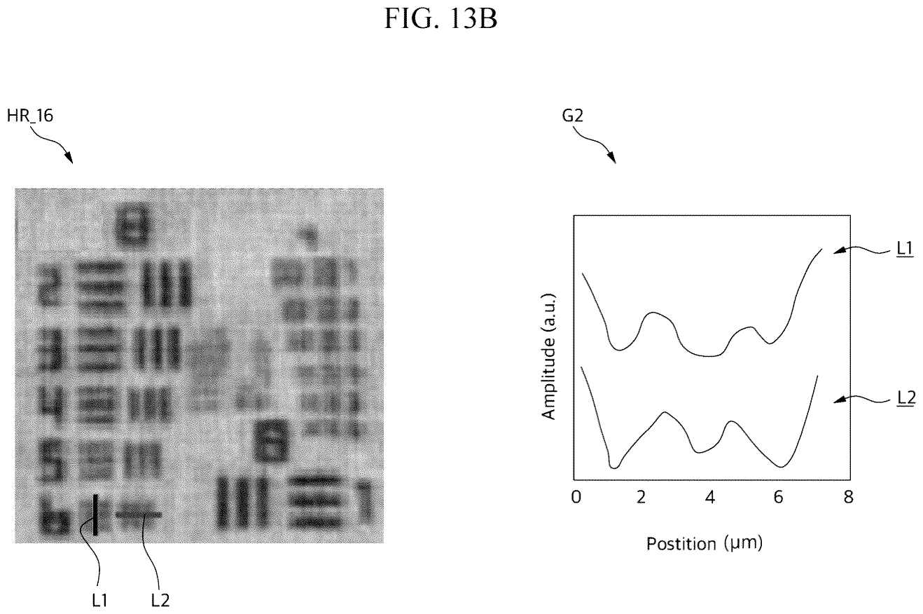

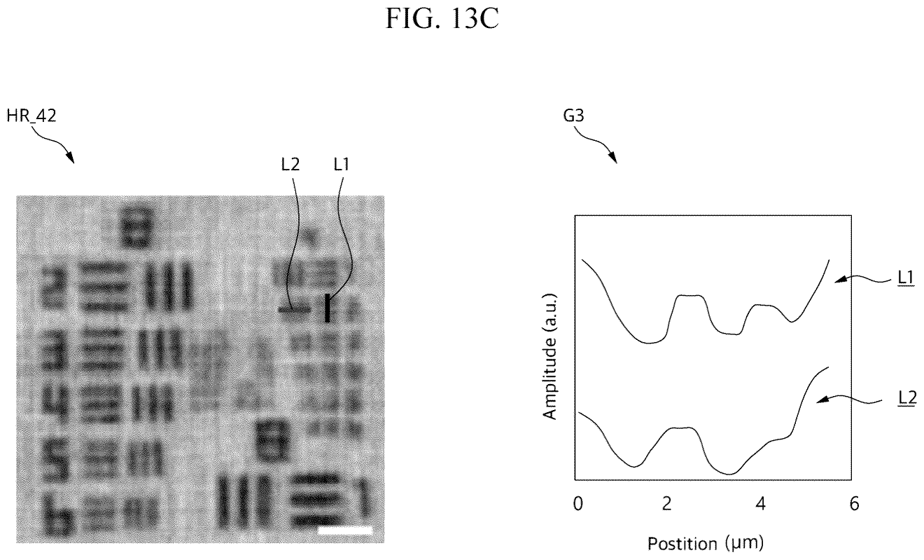

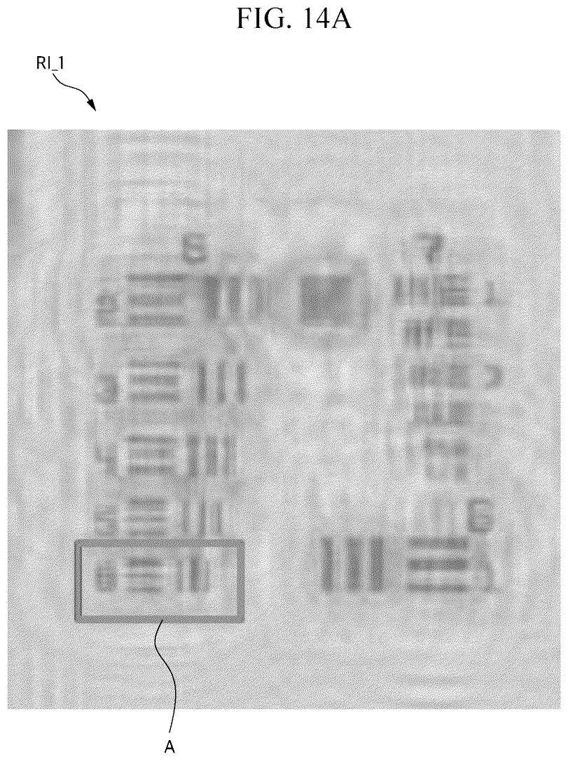

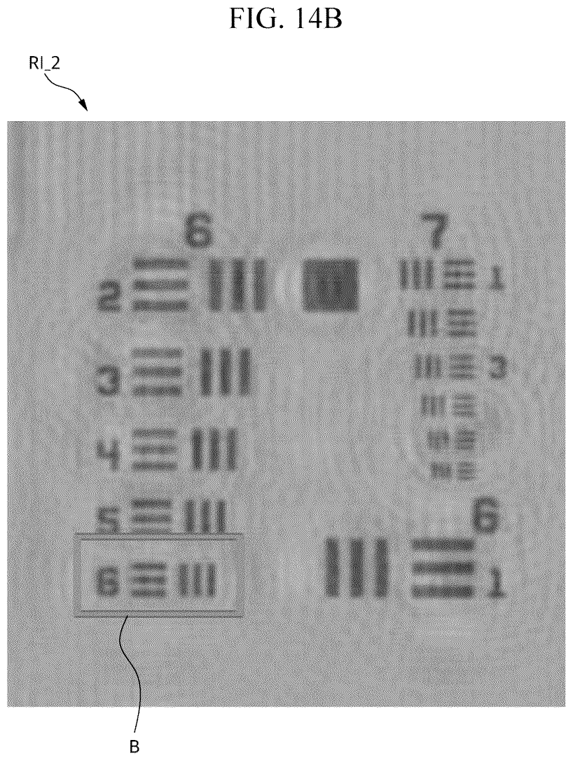

FIGS. 13A to 13C illustrate photographs showing the effect of high-resolution implementation. FIGS. 14A and 14B illustrate photographs showing the effect of high-quality implementation through phase restoration. Hereinafter described with reference to FIGS. 13 and 14 are example embodiments by which high resolution of reconstructed images are achieved according to an inspection apparatus and a method, and effect of the high resolution achievement. Hereinafter, the same reference numerals as in FIGS. 1 to 12 are used.

FIG. 13A illustrates a high resolution diffraction image HR_1 obtained through operation S10 which is the first reconstruction process, with regard to one diffraction image obtained by irradiating the light sources 220 once on the inspection target object S. The high resolution diffraction image HR_1 undergoes operation S10 which is the first reconstruction process with only one low resolution diffraction image, and thus, it is difficult to achieve high resolution implementation, and thus, the fine line widths L1 and L2 of the patterns formed on the inspection target object S are not distinguishable due to the background noise and low resolution. It is also identified by a graph G1, where the difference in amplitude for the patterns present in the areas marked with red and blue lines is not clear.

In addition, FIG. 13B shows a high resolution diffraction image HR_16 obtained through operation S10 which is the first reconstruction process, with regard to 16 low resolution diffraction images obtained by irradiating the light source to the inspection target object S 16 times. Further, FIG. 13C shows a high resolution diffraction image HR_42 obtained through operation S10 which is the first reconstruction process, with regard to 42 low resolution diffraction images obtained by the light sources 220 irradiating the light source 42 times on the inspection target object S. It is shown that the high resolution implementation for the high resolution diffraction image HR_42 obtained by first reconstructing the 42 low resolution diffraction images is higher than the high-resolution implementation for the high resolution diffraction image HR_16 obtained by first reconstructing 16 low resolution diffraction images. It is also identified by difference in amplitude intensity according to the position between a graph G2 and a graph G3 shown in FIGS. 13B and 13C, respectively. In other words, it is shown that the resolution of the high resolution diffraction image HR_42, obtained by first reconstructing 42 diffraction images, is significantly improved up to the point that the fine line widths L1 and L2 of the patterns formed on the object S are clearly distinguished.

FIG. 14A shows an output image RI_1 that does not go through operation S20 which is the second reconstruction process for the high resolution diffraction image. FIG. 14B shows an output image RI_2 that went through operation S20 which is the second reconstruction process for the high resolution diffraction image. FIG. 14A shows that the output image RI_1 contains a twin image artifact and thus it is difficult to distinguish the fine line widths formed in part A. Unlike FIG. 14A, FIG. 14B shows that the twin image artifact is removed in the output image RI_2 and thus the fine line widths formed in part B are clearly distinguished.

Below, an inspection apparatus 10a according to another example embodiment is described. Below, explanations of overlapping content are omitted since the inspection apparatus 10a has the same or similar structure and function as the inspection apparatus 10 described with reference to FIGS. 1 to 4, except where otherwise stated.

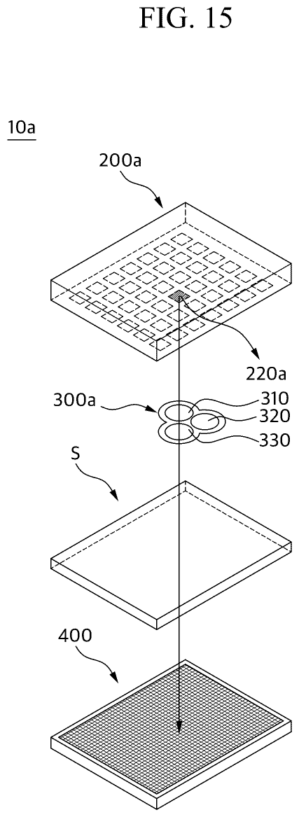

FIG. 15 is a perspective view schematically illustrating an inspection apparatus according to an example embodiment. In FIG. 15, the illustration of the body 100 (see FIG. 2) is omitted.

Referring to FIG. 15, an irradiation part 200a may include a plurality of light sources 220a. The light sources 220a may be provided in a number of natural numbers of at least 2. Further, in example embodiments, the light sources 220a may be a white LED. In other words, the light (that is output and irradiated by the light source 220a) may be white light having a wavelength range of, for example, about 380 nm to 780 nm.

In example embodiments, a filter 300a may include a plurality of filters. For example, the filter 300a may include a first color filter 310, a second color filter 320 and a third color filter 330. The first color filter 310 may transmit light having the first wavelength range. Further, the first color filter 310 may transmit light having the first wavelength range, the second color filter 320 may transmit light with a second wavelength range, and the third color filter 330 may transmit light with a third wavelength range. The first wavelength range, second wavelength range, and third wavelength range can be different ranges. Unlike the example embodiments described above, the filter 300a may include two or more color filters. In those cases, like wise what is described above, each color filter may transmit light of a different wavelength range.

According to example embodiments described above, the light sources 220a may output and irradiate white light, and vary the type and color of light received by the detector 400 by using color filters with different wavelength ranges. Specifically, white light (that is output from the light sources 220a) may pass through the first color filter 310 having first wavelength range, and accordingly, the detector 40 may only receive light in the first wavelength range. By repeating the process as many times as the number of light sources 220a, diffraction images having the corresponding number of first wavelength ranges may be obtained. When this process is carried out in the same way for light having a second wavelength range and light having a third wavelength range, a process identical or similar to the inspection method according to some of the above described example embodiments may be performed, and the same or similar effect may be achieved.

Further, according to another example embodiment, the light source may be an RGB LED with a narrow bandwidth of light output from each light source. For example, a light source according to example embodiments may be an RGB-LED that is designed in order for the bandwidth of each of the red light, the green light, and the blue light output from the light source to be secured to less than or equal to 5% of its central wavelength. In this case, the inspection apparatus may not include the filters described above.

Further, according to another example embodiment, the light source may be an RGB-LED, and the filter may include a multiline color filter. Specifically, the multiline color filter may be an optical filter that is provided as a single filter and selectively pass light having a specific wavelength range. In other words, the multiline color filter may be fixed in position without rotating. The specific wavelength range and bandwidth of light passing through the multiline color filter can vary depending on design requirements.

The above detailed description is illustrative of the disclosure. Further, the above description illustrates and explains preferred example embodiments of the disclosure, and the disclosure may be used in various other combinations, modifications, and environments. In other words, changes and modifications are possible in the scope of the disclosure, the scope that is equivalent to the above description and/or the scope of technology or knowledge in the art. The above example embodiments describes the best state for implementing the technical idea of the disclosure, and various modifications are also possible as required for specific application fields and uses of the disclosure. Therefore, the detailed description of the disclosure is not intended to limit the disclosure to the described example embodiments. Further, the appended claims should be construed to include other example embodiments.

What is claimed is:

1. An inspection method comprising:
obtaining a plurality of diffraction images of an inspection target object by performing a plurality of lighting cycles in which a plurality of light sources are configured to sequentially irradiate light onto the inspection target object; and
obtaining an output image of the inspection target object based on the plurality of diffraction images,
wherein for each of the plurality of lighting cycles, the light irradiated to the inspection target object has a different wavelength range.

2. The inspection method of claim 1, wherein the plurality of light sources are spaced respectively in a predetermined distance from the inspection target object,
wherein the plurality of light sources are respectively placed at different positions on a virtual plane facing the inspection target object, and
wherein each of the plurality of light sources is configured to be turned on/off once in a single cycle of the plurality of lighting cycles.

3. The inspection method of claim 1, wherein the obtaining the plurality of diffraction images comprises:
obtaining a plurality of low resolution diffraction images of the inspection target object by a detector configured to receive the light diffracted from the inspection target object, and
obtaining a stack of diffraction images classified among other low resolution diffraction images obtained from light of a same wavelength range.

4. The inspection method of claim 3, wherein the obtaining the output image comprises a first reconstruction process that comprises:
based on shift amount information of a diffraction pattern of each of the plurality of low resolution diffraction images in the stack of diffraction images, aligning the other low resolution diffraction images to reference positions; and
obtaining a high resolution diffraction image by compositing each of the other low resolution diffraction images aligned to the reference positions.

5. The inspection method of claim 4, wherein the diffraction pattern is different depending on the positions of the plurality of light sources that are turned on/off.

6. The inspection method of claim 4, wherein the shift amount information is calculated based on a distance between the plurality of light sources and the inspection target object, a distance between the inspection target object and the detector, and a distance that the plurality of light sources are spaced from the reference positions.

7. The inspection method of claim 4, wherein a plurality of high resolution diffraction images are obtained for each wavelength range of light, and
wherein the obtaining the output image further comprises a second reconstruction process that comprises obtaining the output image of the inspection target object by reconstructing the plurality of high resolution diffraction images that are obtained for each wavelength range of light by calculating a final amplitude and phase based on a difference in diffraction angle for the each wavelength range of light.

8. The inspection method of claim 1, wherein the plurality of light sources comprise an LED that outputs white light, or at least one of red light, green light and blue light.

9. The inspection method of claim 8, wherein the light passes through a filter and is irradiated onto the inspection target object,
wherein the filter comprises a first color filter, a second color filter and a third color filter configured to rotate around a direction of propagation of the light to change positions,
wherein the first color filter is configured to transmit light of a first wavelength range in incident light,
wherein the second color filter is configured to transmit light of a second wavelength range in the incident light, and
wherein the third color filter is configured to transmit light of a third wavelength range in the incident light.

10. The inspection method of claim 8, wherein the plurality of light sources are configured to output lights for which each bandwidth is adjusted in different wavelength range, and irradiate the lights to the inspection target object.

11. The inspection method of claim 1, wherein the plurality of light sources are configured to output the lights for which the each bandwidth is adjusted, and
wherein the bandwidth is a range of less than or equal to about 5% of a center wavelength of a wavelength range of light that is output from the plurality of light sources.

12. The inspection method of claim 8, wherein the light irradiated from the plurality of light sources passes through an optical filter that is configured to selectively pass light having a number of predetermined wavelength ranges,
wherein the light is irradiated to the inspection target object, and
wherein the optical filter is configured to be fixed in a position in the direction of propagation of the light.

13. The inspection method of claim 1, wherein the inspection target object is a semiconductor.

14. The inspection method of claim 1, wherein the light irradiated from the plurality of light sources passes through the inspection target object along a lens-less path and is received by the detector.

15. The inspection method of claim 1, wherein the inspection target object comprises a light-transmitting material.

16. An inspection method comprising:
sequentially irradiating lights, by a plurality of light sources that are individually turned on/off, onto an inspection target object;
obtaining a plurality of diffraction images of the inspection target object by a detector configured to receive the lights diffracted from the inspection target object; and
obtaining an image of the inspection target object by aligning the plurality of diffraction images based on shift amount information of a diffraction pattern of each of the plurality of diffraction images, and compositing the aligned plurality of diffraction images.

17. The inspection method of claim 16, wherein the diffraction pattern that each of the plurality of diffraction images has is different depending on a position of the plurality of light sources that are configured to be turned on/off.

18. The inspection method of claim 16, wherein the obtaining the image comprises obtaining the plurality of diffraction images being aligned to reference positions, and the reference positions comprising a center of a panel on which the plurality of light sources are placed, and
wherein the shift amount information comprises a vector value of the diffraction pattern from the center of the panel.

19. The inspection method of claim 16, wherein the light irradiated from the plurality of light sources passes through the inspection target object along a lens-less path and the light is received by the detector.

20. An inspection method comprising:
outputting light from a plurality of light sources placed at different positions;
irradiating first light having a first wavelength range, second light having a second wavelength range and third light having a third wavelength range;
obtaining a plurality of first low resolution diffraction images of an inspection target object by a detector configured to receive the first light diffracted from the inspection target object;
obtaining a plurality of second low resolution diffraction images of the inspection target object by the detector configured to receive the second light diffracted from the inspection target object;
obtaining a plurality of third low resolution diffraction images of the inspection target object by the detector configured to receive the third light diffracted from the inspection target object;
based on shift amount information of a diffraction pattern of each of the first low resolution diffraction images, the second low resolution diffraction images and third low resolution diffraction images,
aligning the first low resolution diffraction images, the second low resolution diffraction images and third low resolution diffraction images, and
compositing a first high resolution diffraction image from the aligned first low resolution diffraction images, a second high resolution diffraction image from the aligned second low resolution diffraction images, and a third high resolution diffraction image from the aligned third low resolution diffraction images; and
obtaining an output image of the inspection target object by calculating a final amplitude and phase based on a difference in diffraction angles between a first wavelength range of the first high resolution diffraction image, a second wavelength range of the second high resolution diffraction image and a third wavelength range of the third high resolution diffraction image,
wherein the outputting the light comprises:
a first lighting cycle in which the first light output by each of the plurality of light sources being sequentially turned on/off is irradiated to the inspection target object;
a second lighting cycle in which the second light output by each of the plurality of light sources being sequentially turned on/off is irradiated to the inspection target object; and
a third lighting cycle in which the third light output by each of the plurality of light sources being sequentially turned on/off is irradiated to the inspection target object.
